(19) United States
(12) Patent Application Publication
(10) Pub. No.: US 2007/0274774 A1
(43) Pub. Date: Nov. 29, 2007

(54) Profile for Fixing a Tensioned Cloth

(76) Inventor: Gilles Jacquet, Auberives Sur Vareze (FR)

Correspondence Address: CLARK & BRODY, 1090 VERMONT AVENUE, NW, SUITE 250, WASHINGTON, DC, 20005, US

(21) Appl. No.: 10/565,192

(22) PCT Filed: Jul. 22, 2003
(86) PCT No.: PCT/FR03/02316

§ 371 Date: Mar. 30, 2007

(51) Int. Cl. F16B 5/06

(52) U.S. Cl. 403/338

(57) ABSTRACT

A molding for immobilizing a cloth, cover or the similar in the groove of a supporting structure comprises a core from which at least two elastically deformable wings are extended. Said wings are essentially parallel to each other and remote from each other with the aid of a reinforcing elastically deformable means arranged therebetween. Said invention is characterised in that said reinforcing means comprise at least one arched cross-member extending between the two wings.

This present invention concerns the technical area of devices used for the support of a fabric or of a stretched tarpaulin, for decorative or advertising purposes.

In the aforementioned area, it is common, in order to create a decorative or advertising panel, to create a supporting structure that has at least one peripheral groove in which a rod is inserted, in order to trap within it a fabric or a stretched tarpaulin which is placed within the groove, clamped between the latter and the retaining rod.

Such a supporting structure, constituting a decorative or advertising panel, has been described in particular by patent EP 0 326 487.

According to this document, the rod is composed of one or more sections of a moulding which includes a core from which extend at least two elastically deformable wings, which are more or less parallel to each other and separate from each other. The core has a width that is greater than that of the opening in the peripheral groove, and the elastic wings also have a maximum width that is greater than that of this opening, in order to be trapped in the peripheral groove.

In fact, such a moulding is used to effect the clamping of a tarpaulin or fabric in the peripheral groove of the supporting structure.

However in use, it has emerged that, in certain circumstances, this moulding does not guarantee retention of a stretched tarpaulin with sufficient resistance to pulling out. Now this lack of resistance to pulling out can comprise an obstacle in certain configurations of use, in particular when used to secure tarpaulins of large dimension which can be subjected to relatively large stresses when they are located outdoors and subject to the effects of bad weather, and wind in particular.

The need has therefore arisen for a moulding which is able to provide greater resistance to pulling out than that provided by the clamping moulding employed in previous designs.

To this end, U.S. Pat. No. 5,076,033 proposed a moulding for the securing of a fabric, tarpaulin or similar in a groove of a supporting structure, where the moulding includes a core from which extend at least two elastically deformable wings, more or less parallel to each other and separate from each other, that include an elastically deformable element, positioned parallel to the core between the securing wings.

However, although such a reinforcing element actually enables the stiffness of the wings to be increased, thus adding to the resistance to pulling out of the fixing that has been achieved by insertion of the moulding into a groove of complementary shape, it nevertheless has the disadvantage of requiring particularly high force during insertion of the moulding into its groove. This force can prove to be an impediment.

This therefore gives rise to the need for a new moulding which, while still having greater resistance to pulling out than that of a moulding as described in patent application EP 0 326 487, does not present excessive resistance to insertion. In fact this would be a satisfactory compromise between resistance to pulling out and resistance to the insertion.

To this end, the invention concerns a moulding for the securing of a fabric, tarpaulin or similar, into a groove of a supporting structure, where this moulding includes a core from which extend at least two elastically deformable wings, more or less parallel to each other and separate from each other, as well as elastically deformable reinforcing resources positioned between the wings.

According to the invention, the reinforcing resources include at least one bowed spacer. Thus, this bowed shape of the spacer favours its flexing qualities, so as to reduce the insertion force of the moulding, while still preserving the reinforcing function of the wings.

The moulding according to the invention can be manufactured in any appropriate manner and, in a manner which is preferred but not strictly necessary, the core, the wings and the reinforcing resources form a single-block assembly, so that the moulding according to the invention constitutes a unitary whole. In a preferred manner, the moulding is created from in a plastic material, which is extruded or bowed, through a die.

According to the invention, the bowed spacer can be designed in different ways, depending on the stiffness desired. Likewise, the spacer can then be attached to the wings at different levels in relation to the core of the moulding, as a function of the stiffness desired. Thus, according to one characteristic of the invention, the spacer connects together the ends of the wings located away from the core.

According to yet another characteristic of the invention, the spacer is bowed and the concave side of the spacer is, preferably but not necessarily, oriented away from the core.

According to another characteristic of the invention, the spacer is “V” shaped.

According to the invention, the reinforcing resources can include one or more spacers. Thus, according to one characteristic of the invention, the reinforcing resources include two bowed spacers which extend between the two wings, and whose concave sides are positioned facing each other. Moreover, in this configuration, the vertices of the spacers face each other, and at a certain approach distance of the wings, butt up against each other to prevent any additional closure of the wings.

According to another characteristic of the invention, the moulding includes end-stop resources intended to limit the bending of the bowed spacer. Such end-stop resources can be made in any appropriate manner and, for example, can be formed by a second spacer, as described previously. According to another form of implementation, the end-stop resources are composed of an element or rib projecting from the core of the moulding, in the direction of the spacer.

According to yet another form of implementation of the invention, the end-stop resources are formed by a projecting element extending from the spacer so as to make contact with the core of the moulding during an approach of the wings toward the latter.

According to another characteristic of the invention, the concave side of the bowed spacer is oriented toward the core of the moulding and the vertex of the spacer is located, in relation to the core of the moulding, more or less within or outside of the plane defined by the ends of the wings, so that during installation of the moulding, the stretched fabric comes up against the vertex of the moulding, thus preventing a bending of the spacer and therefore a distancing of the wings from the moulding.

In order to ensure perfect locking of the wings of the moulding, the latter characteristic can be combined with the provision of end-stop resources with which the spacer comes into contact.

According to yet another characteristic of the invention, in order to allow better securing of the moulding in its retention groove, each wing has a relief or a convex securing shape, in the vicinity of its end away from the core and on its outer face.

According to another characteristic of the invention, the base of each wing is located away from the edge closest to the core of the moulding.

According to the invention, the core of the moulding can have different shapes depending on the supporting structure and the groove in which it has to fit. Thus, the core can have a bowed shape. However, according to a characteristic of the invention that is preferred but not strictly necessary, the core of the moulding is more or less flat and the wings extend perpendicularly to the latter.

The invention also concerns a decorative or advertising panel that includes:
a support structure with at least one peripheral groove,
a rod located in the groove in order to clamp within it a stretched fabric or a tarpaulin,

characterised in that the rod is composed of the moulding described above.

Various other characteristics of the invention will emerge from the following description which is provided with reference to the appended drawings, which illustrate different non-limited forms of implementation of a moulding according to the invention and of a decorative or advertising panel employing such a moulding.

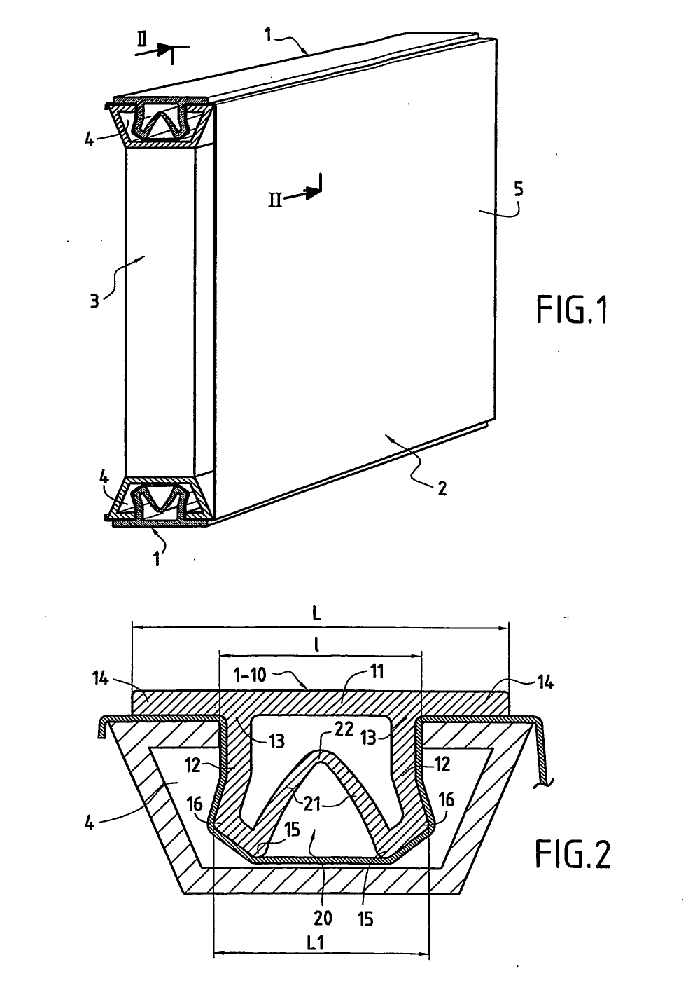

FIG. 1 is a view in perspective, with partial cut-away, of a decorative or advertising panel using a moulding according to the invention.

FIG. 2 is a straight cross section on the plane II-II of FIG. 1 showing a preferred form of implementation of a moulding according to the invention.

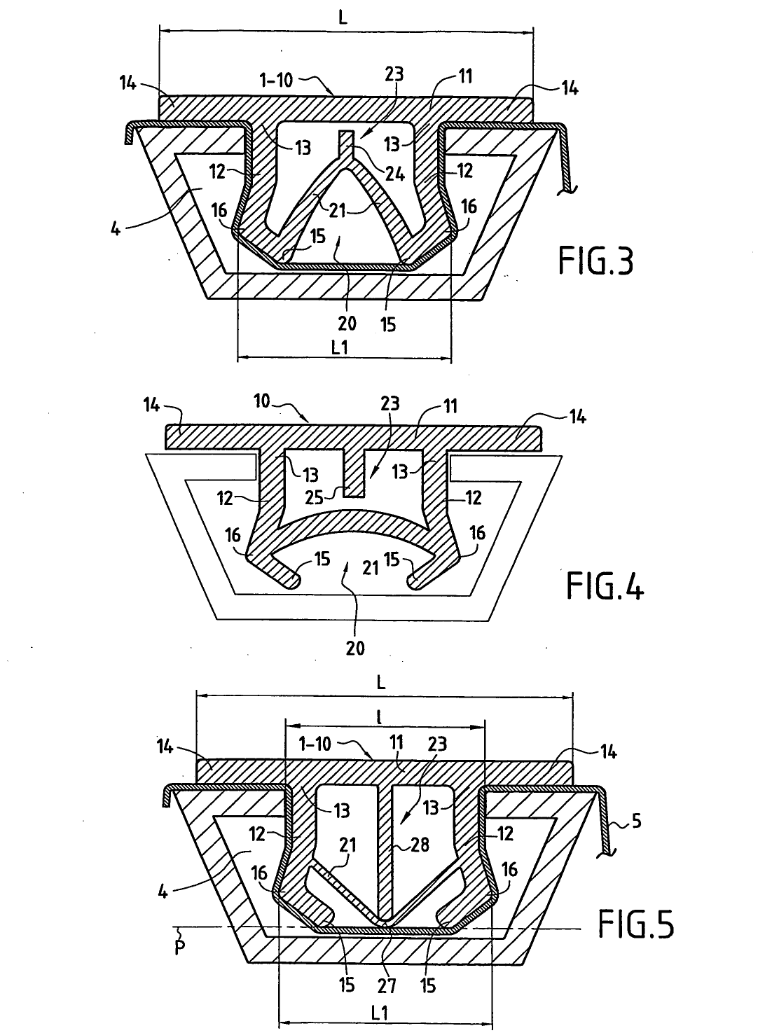

FIGS. 3 to 5 are views in section, similar to FIG. 2, showing different forms of implementation of a clamping moulding according to the invention.

A moulding according to the invention is intended to be composed of a rod 1 inserted into the frame of a decorative or advertising panel, as illustrated in FIG. 1, and designated as a whole by the reference 2. The panel 2 includes a supporting structure 3 which has at least one and, according to the illustrated example, one peripheral groove 4. The panel 2 also includes a fabric or tarpaulin 5 which is clamped or immobilised in the groove 4 by the rod 1.

In order to achieve a securing of the tarpaulin 5 on the supporting structure 3 that provides good resistance to pulling out when a traction force is applied to the tarpaulin or fabric 5, the invention proposes to create the rod 1 in the form of a moulding 10, such as that illustrated on a larger scale in FIG. 2.

As shown in the cross section view of FIG. 2, the moulding 10 includes a core 11 from which extend two wings 12 that are more or less parallel to each other. According to the illustrated example, the core 11 is more or less flat, and the wings 12 extend perpendicularly to the latter. As can be seen from FIG. 2, the wings 12 are separate from each other, and their base 13 is located at a distance from the nearest edge 14 of the core 11. Thus, the core 11 has a width L which is greater than the width 1 of the opening in the groove 4 in which the two wings 12 are intended to be inserted simultaneously. In order to prevent the unwanted extraction of the moulding 10 out of the groove 4, each wing 12 has, in the vicinity of its end 15, away from the core 11, a relief or a convex securing shape 16 created on the outer face of the corresponding wing 12. Thus at the level of this shaping 16, the moulding 10 has a width L₁ that is greater than the width 1 of the opening in the groove 4.

According to an essential characteristic of the invention, in order to increase the stiffness of the elastically deformable wings 12 in opposition to a force which may be applied to them in the direction of approach of the two wings 12. The moulding 10 also includes elastically deformable reinforcing resources 20, positioned between the securing wings 12, and including at least one bowed spacer 21 pinched between the wings 12.

The bowed spacer 21 can, of course, be produced by any appropriate means. According to the illustrated example, the spacer 21 is “V” shaped, and connects together the ends 15 of the wings 12. As shown in FIG. 2, the point 22 of the “V”, defined by the spacer 21 constituting the reinforcing resources 20, is preferably oriented toward the core 11 of the moulding 10.

The moulding 10 thus constituted can be created in any appropriate manner and in any appropriate material. In a manner which is preferred but not strictly necessary, the moulding 10 is made of a plastic material, such as, for example but not exclusively, extruded PVC. The core 11, the wings 12 and the reinforcing resources 20 then form a single-block or unitary assembly which has a low production cost, while still providing particularly satisfactory mechanical characteristics.

The moulding according to the invention thus constituted is employed in the following way. The fabric 5 is positioned on the supporting structure 3, so as to cover the opening in the peripheral groove 4. Next, the rod 1, made from one or more sections of moulding 10 is inserted with force into the groove 4, so as to clamp the fabric 5 between the edges of the opening in the groove 4 and the wings 12. The additional stiffness provided by the reinforcing resources 20 then ensure effective clamping of the fabric 5 between the rod 1 and the rims of the groove 4. Moreover, the bowed shape of the spacer encourages it to bend and thus allows the wings 12 to approach each other during introduction of the moulding 10 into the groove 4. Thus, the spacer 21 increases the stiffness of the wings 12 without however completely preventing them from moving toward each other.

FIG. 3 illustrates an implementation variant of the moulding 10, as illustrated in FIG. 2, according to which the moulding 10 includes end-stop resources 23 intended to limit the movements of the spacer 21 in either direction.

According to the example illustrated in FIG. 3, the end-stop resources 23 are designed to oppose the bending of the spacer 21 after a certain point of approach of the wings 12. Thus, the end-stop resources 23 include a projecting rib element 24, extending from the vertex of the spacer 21 in the direction of the core 11. Thus, during the approach of the wings 12, the projecting rib 24 makes contact with the core 11 and stops further bending of the spacer 21.

In addition, the presence of the rib 24, when the spacer is engaged, acts enables one to ensure correct distancing of the wings 12 by tapping the back of the core 11 with a mallet.

According to the invention, these end-stop resources 23 are not necessarily attached to the spacer 21.

Thus, FIG. 4 illustrates another form of implementation according to which the end-stop resources 23 include a projecting rib 25 attached to the core and extending in the direction of the vertex of the spacer 21. It should be noted that, according to this example, the bowed spacer 21 is not “V” shaped, but has the shape of a circular arc.

FIG. 5 illustrates yet another form of implementation of a moulding according to the invention. According to this example, the reinforcing resources 20 include a bowed spacer 21 whose concave side is oriented toward the core 11 and whose vertex 27 is positioned so that, in the rest position of the moulding, it is more or less in the plane P defined by the ends 15 of the wings 12 or indeed outside of plane P in relation to the core 11. In the assembly position illustrated in FIG. 5, this advantageous feature of the invention allows the fabric 5 to exert a pressure on the vertex 27 in the direction of separation of the wings 12, thus contributing to good securing of the moulding 10 in the groove 4.

According to this example, though not strictly necessary, the moulding 10 also includes end-stop resources 23 composed of a rib 28 extending from the core 11 toward the spacer 21. In the assembly position, as illustrated in FIG. 5 and in combination with the fabric 5, this rib 28 is used, firstly, to limit the bending movements of the spacer 21 and therefore to lock the position of the wings 12. Secondly it is possible, by virtue of the rib 28, during the insertion of the moulding 10 into the groove 4, to make sure that the wings 12 approach each other by striking the back of the core 11 with a mallet.

In fact, given the elasticity of the core 11, the blow applied to the core 11 displaces the rib 28 in the direction of the hollow in the spacer 21 which bends, thus pushing the wings 12 together. This advantageous feature contributes to easing the insertion of the moulding into the groove.

Of course, the end-stop resources 23 may not be composed of a single rib, but rather of two ribs, one extending from the core and the other from the spacer, designed, for example, to come into contact with each other.

1. A moulding for the securing of a fabric, tarpaulin or similar in a groove of a supporting structure, where this moulding includes a core (11) from which extend at least two elastically deformable wings (12), more or less parallel to each other and separate from each other, as well as elastically deformable reinforcing resources (20) positioned between the wings (12),
characterised in that the reinforcing resources (20) include at least one bowed spacer (21) extending between the two wings (12).

2. A moulding according to claim 1, characterised in that the core (11), the wings (12) and the bowed spacer (21) form a single-block assembly.

3. A moulding according to claim 2, characterised in that the spacer (21) connects the ends (15) of the wings (12) located away from the core (11).

4. A moulding according to claim 1, characterised in that, firstly, the concave side of the bowed spacer (21) is oriented toward the core (11) and, secondly, the vertex (27) of the spacer lies more or less in the plane (P) defined by the ends (15) of the wings (12) or outside of plane (P) in relation to the core (11).

5. A moulding according to claim 1, characterised in that the concave side of the spacer (21) is oriented away from the core.

6. A moulding according to claim 1, characterised in that the spacer (21) is “V” shaped.

7. A moulding according to claim 1, characterised in that it includes end-stop resources (23) intended to limit the movements of the spacer (21).

8. A moulding according to claim 7, characterised in that the end-stop resources (23) include at least one rib (24) attached to the spacer (21) extending in the direction of the core (11).

9. A moulding according to claim 7, characterised in that the end-stop resources (23) include at least one rib (25, 28), attached to the core (25), extending in the direction of the spacer (21).

10. A moulding according to claim 1, characterised in that each wing (12) has a convex securing shape (16), in the vicinity of its end (15) away from the core (11) and on its outer face.

11. A moulding according to claim 1, characterised in that the base (13) of each wing (12) is located at a distance from the nearest edge (14) of the core of the moulding (11).

12. A moulding according to claim 1, characterised in that the core (11) is more or less flat.

13. A decorative or advertising panel that includes:
a support structure (3) which has at least one peripheral groove (4),
a rod (1) inserted into in the groove (4) in order to clamp within it a stretched fabric or tarpaulin (5),
characterised in that the rod (1) is composed of a moulding according to claim 1.
